(19) United States
(12) Patent Application Publication
(10) Pub. No.: US 2016/0105685 A1
(43) Pub. Date: Apr. 14, 2016

(54) BOUNDARY FILTERING AND CROSS-COMPONENT PREDICTION IN VIDEO CODING

(71) Applicant: QUALCOMM Incorporated, San Diego, CA (US)

(72) Inventors: Feng Zou, San Diego, CA (US); Rajan Laxman Joshi, San Diego, CA (US); Wei Pu, San Diego, CA (US); Marta Karczewicz, San Diego, CA (US)

(21) Appl. No.: 14/877,779

(22) Filed: Oct. 7, 2015

Related U.S. Application Data
(60) Provisional application No. 62/061,653, filed on Oct. 8, 2014.

(51) Int. Cl. H04N 19/593; H04N 19/44; H04N 19/186; H04N 19/176; H04N 19/117

(52) U.S. Cl. CPC H04N 19/593; H04N 19/176; H04N 19/117; H04N 19/186; H04N 19/44

(57) ABSTRACT

Techniques for coding video data include determining that a block of a first component of the video data is intra-predicted using one of a DC mode, a horizontal mode, or a vertical mode, determining that a corresponding block of a second component of the video data is intra-predicted using the same mode as the block of the first component according to a direct mode to form a predicted block for the second component, and boundary filtering the predicted block in response to the determinations. In some examples, the first component is a luma component, and the second component is a chroma component.

This application claims the benefit of U.S. Provisional Application No. 62/061,653, filed Oct. 8, 2014, which is hereby incorporated by reference in its entirety.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), ITU-T H.265, High Efficiency Video Coding (HEVC), and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences, For block-based video coding, a video slice (i.e., a picture or a portion of a picture) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the spatial domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques related to boundary filtering and cross-component prediction when intra-predicting different color components, such as luma and chroma components, or green, red, and blue components, of video data.

In some examples, a video coder, e.g., a video encoder and/or a video decoder, determines that a block of a first component of the video data is intra-predicted using one of a DC mode, a horizontal mode, or a vertical mode, and determines that a corresponding block of a second component of the video data is intra-predicted using the same mode as the block of the first component according to a direct mode to form a predicted block for the second component. In such examples, the video coder boundary filters the predicted block in response to the determinations.

In some examples, the video coder further determines that cross-component prediction is used to predict a residual for the corresponding block of the second component based on a residual for the block of the first component, and boundary filters the predicted block in response to the determinations that the block of the first component is intra-predicted using one of the DC mode, the horizontal mode, or the vertical mode, the corresponding block of the second component is intra-predicted using the same mode as the block of the first component according to the direct mode, and cross-component prediction is used to predict the residual for the corresponding block of the second component based on the residual for the block of the first component.

In one example, a method of decoding video data comprises determining that a block of a first component of the video data is intra-predicted using one of a DC mode, a horizontal mode, or a vertical mode, and determining that a correspondingblock of a second component of the video data is intra-predicted using the same mode as the block of the first component according to a direct mode to form a predicted blockfor the second component. The method further comprises boundary filtering the predicted block in response to the determinations, and reconstructing the block of the second component using the boundary filtered predicted block.

In another example, a method of encoding video data comprises determining that a block of a first component of the video data is intra-predicted using one of a DC mode, a horizontal mode, or a vertical mode, and determining that a corresponding block of a second component of the video data is intra-predicted using the same mode as the block of the first component according to a direct mode to form a predicted block for the second component. The method further comprises boundary filtering the predicted block in response to the determinations, and encoding the block of the second component using the boundary filtered predicted block.

In another example, a video decoding device comprises a memory configured to store video data, and one or more processors connected to the memory. The one or more processors are configured to determine that a block of a first component of the video data is intra-predicted using one of a DC mode, a horizontal mode, or a vertical mode, and determine that a corresponding block of a second component of the video data is intra-predicted using the same mode as the block of the first component according to a direct mode to form a predicted block for the second component. The one or more processors are further configured to boundary filter the predicted block in response to the determinations, and reconstruct the block of the second component using the boundary filtered predicted block.

In another example, a video encoding device comprises a memory configured to store video data, and one or more processors connected to the memory. The one or more processors are configured to determine that a block of a first component of the video data is intra-predicted using one of a DC mode, a horizontal mode, or a vertical mode, and determine that a corresponding block of a second component of the video data is intra-predicted using the same mode as the block of the first component according to a direct mode to form a predicted block for the second component. The one or more processors are further configured to boundary filter the predicted block in response to the determinations, and encode the block of the second component using the boundary filtered predicted block.

In another example, a method of decoding video data comprises decoding a residual block for a second component of the video data, determining that a predicted block of a first component of the video data was boundary filtered, and inverse cross-component predicting the residual block, excluding the first column and the first row of the residual block, based on the determination. The method further comprises reconstructing a video block of the second component using the residual block of the second component that, other than the first column and the first row, was inverse cross-component predicted.

In another example, a method of encoding video data comprises determining that a predicted block of a first component of the video data was boundary filtered, determining a residual block of a second component of the video data, and cross-component predicting the residual block, excluding the first column and the first row of the residual block, based on the determination that the predicted block of the first component was boundary filtered. The method further comprises encoding the residual block of the second component that, excluding the first column and first row, was cross-component predicted.

In another example, a video decoding device comprises a memory configured to store video data, and one or more processors connected to the memory. The one or more processors are configured to decode a residual block for a second component of the video data, determine that a predicted block of a first component of the video data was boundary filtered, and inverse cross-component predict the residual block, excluding the first column and the first row of the residual block, based on the determination. The one or more processors are further configured to reconstruct a video block of the second component using the residual block of the second component that, other than the first column and the first row, was inverse cross-component predicted.

In another example, a video encoding device comprises a memory configured to store video data, and one or more processors connected to the memory. The one or more processors are configured to determine that a predicted block of a first component of the video data was boundary filtered, determine a residual block of a second component of the video data, and cross-component predict the residual block, excluding the first column and the first row of the residual block, based on the determination that the predicted block of the first component was boundary filtered. The one or more processors are further configured to encode the residual block of the second component that, excluding the first column and the first row, was cross-component predicted.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram illustrating an example video encoding and decoding system that may utilize the techniques of this disclosure for boundary filtering and cross-component prediction.

FIG. 2 is a conceptual diagram illustrating boundary filtering of a predicted block for a current video block.

FIG. 3 is a block diagram illustrating an example of video encoder that may implement techniques of this disclosure for boundary filtering and cross-component prediction.

FIG. 4 is a block diagram illustrating an example of video decoder that may implement techniques of this disclosure for boundary filtering and cross-component prediction.

FIG. 5 is a flow diagram illustrating an example technique for boundary filtering a predicted block of a second component that may be implemented by a video encoder.

FIG. 6 is a flow diagram illustrating an example technique for boundary filtering a predicted block of a second component that may be implemented by a video decoder.

FIG. 7 is a flow diagram illustrating an example technique for cross-component prediction that may be implemented by a video encoder.

FIG. 8 is a flow diagram illustrating an example technique for cross-component prediction that may be implemented by a video decoder.

### DETAILED DESCRIPTION

Recently, the design of a new video coding standard, namely High-Efficiency Video Coding (HEVC), has been finalized by the Joint Collaboration Team on Video Coding (JCT-VC) of ITU-T Video Coding Experts Group (VCEG) and ISO/IEC Motion Picture Experts Group (MPEG). The latest HEVC specification, referred to as HEVC Version 1 hereinafter, is available from http://www.itu.int/rec/T-REC-H.265-201304-I. The HEVC standard document is published as ITU-T H.265, Series H: Audiovisual and Multimedia Systems, infrastructure of audiovisual services—Coding of moving video, High efficiency video coding, Telecommunication Standardization Sector of International Telecommunication Union (ITU), April 2015.

The Range Extensions to HEVC, namely HEVC-RExt, has reached the status of a final draft international standard (FDIS) and is available from http://phenix.int-evry.fr/jct/doc _end_user/documents/17_Valencia/wg11/JCTVC-Q1005-v9.zip. Recently, JCT-VC has started the development of screen content coding (SCC) extension, which is based on HEVC-RExt. In the 18^{th} JCT-VC meeting in Sapporo Japan in July 2014, and the first working draft for the SCC extension was created and is available to download from http://phenix.int-evry.fr/jet/doc_end_user/documents/18_Sapporo/wg11/JCTVC-R1005-v3,zip.

A video coder (e.g., a video encoder or decoder) is generally configured to code a video sequence, which is generally represented as a sequence of pictures. Typically, the video coder uses block-based coding techniques to code each of the sequences of pictures. As part of block-based video coding, the video coder divides each picture of a video sequence into blocks of data. The video coder codes (e.g., encodes or decodes) each of the blocks.

Encoding a block of video data generally involves encoding an original block of data by identifying, one or more predictive blocks for the original block, and a residual block that corresponds to differences between the original block and the one or more predictive blocks. Specifically, the original block of video data includes a matrix of pixel values, which are made up of one or more “samples,” and the predictive block includes a matrix of predicted pixel values, each of which are also made up of predictive samples. Each sample of a residual block indicates a pixel value difference between a sample of a predictive block and a corresponding sample of the original block.

Prediction techniques for a block of video data are generally categorized as intra-prediction or inter-prediction. Intra-prediction (e.g., spatial prediction) generally involves predicting a block from pixel values of neighboring, previously coded blocks within the same picture. Inter-prediction generally involves predicting the block from pixel values of previously coded blocks in previously coded pictures.

The pixels of each block of video data each represent color in a particular format, referred to as a “color representation.” Different video coding standards may use different color representations for blocks of video data. As one example, the main profile of HEVC uses the YCbCr color representation to represent the pixels of blocks of video data.

The YCbCr color representation generally refers to a color representation in which each pixel of video data is represented by three components or channels of color information, “Y,” “Cb,” and “Cr.” The Y channel represents luminance (i.e., light intensity or brightness) data for a particular pixel. A component generally refers to an array or single sample from one of the three arrays (luma and multiple chroma) that compose a picture in color formats such as 4:2:0, 4:2:2, or 4:4:4 or the array or a single sample of the array that compose a picture in monochrome format. The Cb and Cr components are the blue-difference and red-difference chrominance, i.e., “chroma,” components, respectively. YCbCr is often used to represent color in compressed video data because there is typically a decorrelation between each of the Y, Cb, and Cr components, meaning that there is little data that is duplicated or redundant among each of the Y, Cb, and Cr components. Coding video data using the YCbCr color representation therefore offers good compression performance in many cases.

Additionally, many video coding techniques utilize a technique, referred to as “chroma subsampling” to further improve compression of color data. Chroma sub-sampling of video data having a YCbCr color representation reduces the number of chroma values that are signaled in a coded video bitstream by selectively omitting chroma components according to a pattern. In a block of chroma sub-sampled video data, there is generally a luma value for each pixel of the block. However, the Cb and Cr components may only be signaled for some of the pixels of the block, such that the chroma components are sub-sampled relative to the luma component. A video coder (which may refer to a video encoder or a video decoder) may interpolate Cb and Cr components for pixels where the Cb and Cr values are not explicitly signaled for chroma sub-sampled blocks of pixels.

The HEVC HEVC-RExt and SCC Extension add support to HEW for additional color representations (also referred to as “color formats”). The support for other color formats may include support for encoding and decoding GBR and RGB sources of video data, as well as video data having other color representations and using different chroma subsampling patterns than the HEVC main profile.

As mentioned above, the HEVC main profile uses YCbCr because of the strong color decorrelation between the luma component, and the two chroma components of the color representation (also referred to as a color format). In many cases, however, there may still be correlations among the various components. The correlations between components of a color representation may be referred to as cross-color component correlation or inter-color component correlation.

Cross-component prediction (CCP) may exploit the correlation between samples in the residual domain. A video coder (e.g., a video encoder or a video decoder) configured in accordance with the techniques of this disclosure may be configured to determine blocks of chroma residual samples from predictors of blocks of chroma residual samples and blocks of luma residual samples that correspond to each other. In some examples, an updated block of chroma residual values may be determined based on a predictor for the block of chroma residual samples and a corresponding block of luma residual samples. The block of luma residual samples may be modified with a scale factor and/or an offset.

CCP may be applied to video data having a 4:4:4 chroma format, e.g., in which the chroma components are not sub-sampled. In some examples, the Cb/B and Cr/R residuals are predicted from the Y/G residuals. In some example, for intra-coded blocks, CCP can be used only when the chroma prediction mode is direct mode (DM), meaning that the chroma prediction mode is the same as the luma prediction mode.

As used herein, the term “first component” may refer to one of the color components according to the color format of the video data, such as the Y component in YCbCr video data, the G component in GBR video data, and the R component in RGB video data. As used herein, the term “second component” may refer to another of the color components, such as either of the chrominance components of YCbCr video data, the B or R components of GBR video data, or the G or B components of RGB video data.

Although many examples herein are described with respect to only a first component and a second component, the techniques of this disclosure may additionally be applied to a third component, or any additional component, e.g., in the same manner as or similar manner to their application to the second component. Depending on the video sampling format, the size of the other components, e.g., the chrominance components, in terms of number of samples, may be the same as or different from the size of the first component, e.g., the luminance component.

As discussed above, many video coding standards, such as HEVC, implement intra-prediction. A video coder may use various intra-prediction modes to generate a predictive block. The intra-prediction modes may include angular intra-prediction modes, a planar intra-prediction mode, and a DC intra-prediction mode. The angular intra-prediction modes may include a horizontal prediction mode and a vertical prediction mode.

A video coder, e.g., video encoder or video decoder, may boundary filter, i.e., apply a boundary filter to, a predictive block. In some examples, boundary filtering modifies the values of samples in the first (e.g., top) row and/or the first (e.g., left-most) column of the predictive block using reference samples from one or more neighboring blocks. In some examples, boundary filtering is applied when the prediction mode is DC, horizontal, or vertical. In some examples, boundary filtering is only applied to the predictive block for the first component, but not the second or third components. For example, boundary filtering may be applied only to the predictive block for the Y component, but not the predictive blocks for the Cb and Cr components. As another example, if the format is GBR 4:4:4, boundary filtering may be applied only to the predictive block for the G component, but not the predictive blocks for the B and R components.

There may be problems associated with the interaction of CCP and boundary filtering. For example, if the luma prediction mode is DC, horizontal, or vertical for the current block, the luma residual block may be determined based on a predictive block that is boundary filtered. If CCP is used for the current block, the chroma residuals may be predicted based on the luma residual. However, unlike the luma predictive block, the chroma predictive blocks may not be boundary filtered. Consequently, the prediction of the chroma residuals using CCP may be less accurate and/or effective.

Li et al., “CE9: Result of Test A.2,” Document: JCTVC-S0082, Joint Collaborative Team on Video Coding (JCT-VC) of ITU-T SG 16 WP 3 and ISO/IEC JTC 1/SC 29/WG 11 19^{th} Meeting: Strasbourg, FR 17-24 Oct. 2014 (hereinafter “JCTVC-S0082”), described enabling boundary filtering for the second and third, e.g., chroma, components, in addition to the first, e.g., luma, component. However, JCTVC-50082 proposed enabling boundary filtering for the second and third components without regard to whether CCP was used for the current block. Extending boundary filtering in the manner proposed by JCTVC-S0082 increases the amount of boundary filtering substantially and the benefits are not clear-cut. For example, Zhang et al., “CE9 Test A.1: Optionally disabling the usage of the intra boundary filters,” Document: JCTVC-S0102, Joint Collaborative Team on Video Coding (JCT-VC) of ITU-T SG 16 WP 3 and ISO/IEC JTC 1/SC 29/WG11 19^{th} Meeting: Strasbourg, FR 17-24 Oct. 2014 (hereinafter “JCTVC-S0102”) described turning off boundary filtering for all the components, which also showed BD-rate improvement.

According to the techniques of this disclosure, a video coder, e.g., a video encoder or video decoder, may determine that a block of a first component of the video data is intra-predicted using one of a DC mode, a horizontal mode, or a vertical mode, determine that a corresponding block of a second component of the video data is intra-predicted using the same mode as the block of the first component according to a direct mode to form a predicted block for the second component, and boundary filter the predicted block in response to the determinations.

In some examples, the video coder further determines that CCP is used to predict a residual for the corresponding block of the second component based on a residual for the block of the first component. In such examples, boundary filtering the predicted block in response to the determinations comprises boundary tittering the predicted block in response to the determinations that the block of the first component of the video data is intra-predicted using one of a DC mode, a horizontal mode, or a vertical mode, that a corresponding block of a second component of the video data is intra-predicted using the same mode as the block of the first component according to a direct mode, and that cross-component prediction is used to predict the residual for the corresponding block of the second component based on the residual for the block of the first component,

In some examples, the video coder codes, e.g., encodes or decodes, a syntax element that indicates whether or the predicted block is boundary tittered in response to the determinations. In somec examples, the syntax element may be a flag, In such examples, if the syntax element has a first value, e.g., 0, boundary filtering is only applied to the first component, e.g., the luma component, when the block is intra-coded and the intra prediction mode is DC, horizontal, or vertical, e.g., as specified in the current HEVC, RExt, and SCC specifications. If the syntax element has a second value, e.g., 1, boundary filtering may be applied to the second and third components, e.g., chroma components, according to the techniques described herein.

According to other techniques of this disclosure, which need not be practiced with the techniques described in the preceding paragraphs, a video coder determines that a predicted block of a first component of the video data was boundary filtered and, based on the determination, applies cross-component prediction to predict values of a residual block of a second component of the video data, excluding values of a first column and values of a first row of the residual block, based on corresponding values of a residual block of the first component.

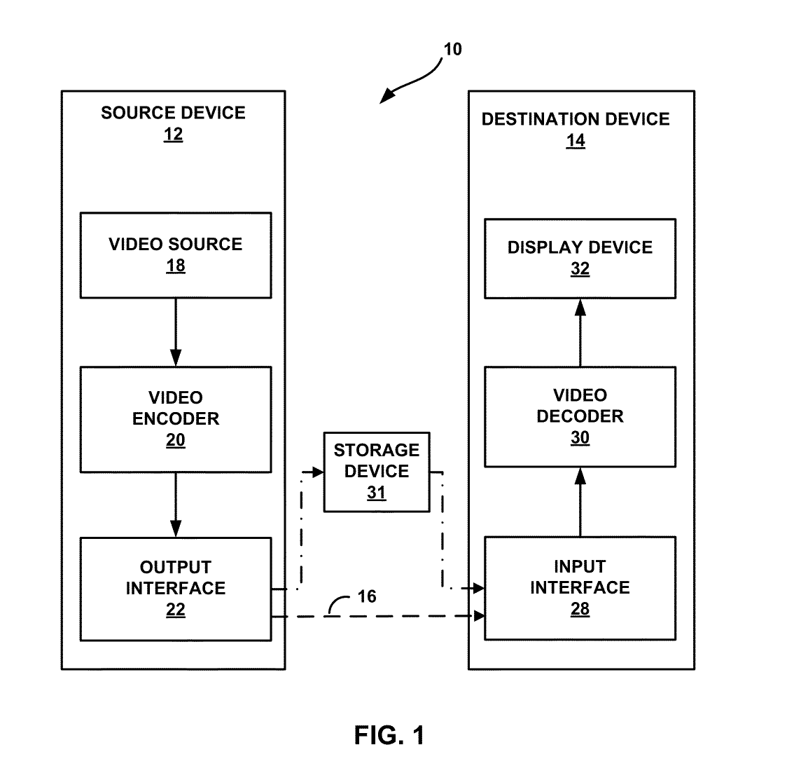

FIG. 1 is a block diagram illustrating an example video encoding and decoding system 10 that may utilize the techniques of this disclosure for boundary filtering and cross-component prediction when intra-predicting different color components, such as the luma and chroma components, or the green, red, and blue components, of video data. As shown in FIG. 1, system 10 includes a source device 12 that generates encoded video data to be decoded at a later time by a destination device 14. In particular, source device 12 provides the video data to destination device 14 via a computer-readable medium (such as storage device 31) or a link 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device. In some cases, source device 12 and destination device 14 may be equipped for wireless communication.

Destination device 14 may receive the encoded video data to be decoded via storage device 31. Storage device 31 may comprise any type of medium or device capable of moving the encoded video data from source device 12 to destination device 14. In one example, storage device 31 may comprise a communication medium to enable source device 12 to transmit encoded video data directly to destination device 14. In another example, link 16 provides a communications medium used by source device 12 to transmit encoded video data directly to destination device 14.

The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device 31. Similarly, encoded data may be accessed from the storage device 31 by input interface 28. The storage device 31 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device 31 may correspond to a file server or another intermediate storage device that may store the encoded video generated by source device 12.

Destination device 14 may access stored video data from the storage device 31 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device 31 may be a streaming transmission, a download transmission, or a combination thereof.

The techniques of this disclosure are not limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of source device 12 may be configured to apply the techniques for boundary filtering and cross-component prediction when intra-predicting different color components, such as the luma and chroma components, or the green, red, and blue components, of video data. In other examples, a source device and a destination device may include other components or arrangements. For example, source device 12 may receive video data from an external video source 18, such as an external camera. Likewise, destination device 14 may interface with an external display device, rather than including an integrated display device. In addition, if video source 18 is a video camera, source device 12 and destination device 14 may form so-called camera phones or video phones. The techniques described in this disclosure may be applicable to video coding in general, and may be applied to wireless and/or wired applications.

The illustrated encoding and decoding system 10 of FIG. 1 is merely one example. Techniques for boundary filtering and cross-component prediction may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium such as storage 31 or to destination device 14 via link 16.

A computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility may receive encoded video data from source device 12 and produce a disc containing the encoded video data. Therefore, computer-readable medium may be understood to include one or more computer-readable media of various forms, in various examples.

This disclosure may generally refer to video encoder 20 “signaling” certain information to another device, such as video decoder 30. It should be understood, however, that video encoder 20 may signal information by generating syntax elements and associating the syntax elements with various encoded portions of video data. That is, video encoder 20 may “signal” data by storing certain syntax elements to headers of various encoded portions of video data. In some cases, such syntax elements may be generated, encoded, and stored (e.g., stored to the computer-readable medium) prior to being received and decoded by video decoder 30. Thus, the term “signaling” may generally refer to the communication of syntax or other data for decoding compressed video data, whether such communication occurs in real- or near-real-time or over a span of time, such as might occur when storing syntax elements to a medium at the time of encoding, which then may be retrieved by a decoding device at any time after being stored to this medium.

Input interface 28 of destination device 14 receives information from storage 31. The information of a computer-readable medium such as storage device 31 may include syntax information defined by video encoder 20, which is also used by video decoder 30, that includes syntax elements that describe characteristics and/or processing of blocks and other coded units, e.g., groups of pictures (GOPs). Display device 32 displays the decoded video data to a user, and may comprise any of a variety of display devices such as a cathode ray tube (CRT), a liquid crystal display (LCD), a plasma display, an organic light emitting diode (MED) display, or another type of display device.

Although not shown in FIG. 1, in some aspects, video encoder 20 and video decoder 30 may each be integrated with an audio encoder and decoder, and may include appropriate MUX-DEMUX units, Of other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). A device including video encoder 20 and/or video decoder 30 may comprise an integrated circuit, a microprocessor, and/or a wireless communication device, such as a cellular telephone.

In one example approach, video encoder 20 encodes a block of video data according to the techniques of this disclosure. For example, video encoder 20 may determine that a block of a first component of the video data is intra-predicted using one of a DC mode, a horizontal mode, or a vertical mode, and determine that a corresponding block of a second component of the video data is intra-predicted using the same mode as the block of the first component according to a direct mode to form a predicted block for the second component. Video encoder 20 boundary filters the predicted block in response to the determinations, and encodes the block of the second component using the boundary filtered predicted block.

In another example approach, video decoder 30 decodes video data according to the techniques of this disclosure. For example, video decoder 30 may determine that a block of a first component of the video data is intra-predicted using one of a DC mode, a horizontal mode, or a vertical mode, and determine that a corresponding block of a second component of the video data is intra-predicted using the same mode as the block of the first component according to a direct mode to form a predicted block for the second component. The video decoder further boundary filters the predicted block in response to the determinations, and reconstructs the block of the second component using the boundary filtered predicted block.

In another example approach, a device 12 includes a memory configured to store video data and one or more processors connected to the memory. The one or more processors are configured to determine that a block of a first component of the video data is intra-predicted using one of a DC mode, a horizontal mode, or a vertical mode, and determine that a corresponding block of a second component of the video data is intra-predicted using the same mode as the block of the first component according to a direct mode to form a predicted block for the second component. The one or more processors are further configured to boundary filter the predicted block in response to the determinations, and encode the block of the second component using the boundary filtered predicted block.

In another example approach, a device 14 includes a memory configured to store video data and one or more processors connected to the memory. The one or more processors are configured to determine that a block of a first component of the video data is intra-predicted using one of a DC mode, a horizontal mode, or a vertical mode, and determine that a corresponding block of a second component of the video data is intra-predicted using the same mode as the block of the first component according to a direct mode to form a predicted block for the second component. The one or more processors are further configured to boundary filter the predicted block in response to the determinations, and reconstruct the block of the second component using the boundary filtered predicted block.

In another example approach, video encoder 20 determines that a predicted block of a first component of the video data was boundary filtered, determines a residual block of a second component of the video data, and cross-component predicts the residual block, other than the first column and the first row of the residual block, based on the determination that the predicted block of the first component was boundary filtered. Video encoder 20 further encodes the residual block of the second component that was cross-component predicted, other than the first column and the first row

In another example approach, video decoder 30 decodes a residual block for a second component of the video data, determines that a predicted block of a first component of the video data was boundary filtered, and inverse cross-component predicts the residual block, other than the first column and the first row of the residual block, based on the determination. Video decoder 30 reconstructs a video block of the second component using the residual block of the second component that was inverse cross-component predicted, other than the first column and the first row

In another example approach, a device 12 includes a memory configured to store video data and one or more processors connected to the memory. The one or more processors are configured to determine that a predicted block of a first component of the video data was boundary filtered, determine a residual block of a second component of the video data, and cross-component predict the residual block, other than the first column and the first row of the residual block, based on the determination that the predicted block of the first component was boundary filtered. The one or more processors are further configured to encode the residual block of the second component that was cross-component predicted, other than the first column and the first row.

In another example approach, a device 14 includes a memory configured to store video data and one or more processors connected to the memory. The one or more processors are configured to decode a residual block for a second component of the video data, determine that a predicted block of a first component of the video data was boundary filtered, and inverse cross-component predict the residual block, other than the first column and the first row of the residual block, based on the determination. The one or more processors are further configured to reconstruct a video block of the second component using the residual block of the second component that was inverse cross-component predicted, other than the first column and the first row.

Video encoder 20 and video decoder 30, in some examples, may operate according to a video coding standard, such as the HEVC and may conform to the HEVC Test Model (HM). HEVC was developed by the Joint Collaboration Team on Video Coding (JCT-VC) of ITU-T Video Coding Experts Group (VCEG) and ISO/IEC Motion Picture Experts Group (MPEG) and approved as ITU-T H.265 and ISO/IEC 23008-2. The current version of ITU-T H.265 is available at www.itu.int/rec/T-REC-H.265. One Working Draft of the Range extensions to HEVC, referred to as RExt WD7 hereinafter, is available from http://phenix,int-evry.fr/jct/doc_end_user/documents/17_Valencia/wg11/JCTVC-Q1005-v8.zip. One working draft of the Screen Content Coding extension to HEVC, referred to as SCC WD3 hereinafter, is available from: http://phenix,int-evry,fr/jct/doc_end_user/current_document.php?id=10025.

In HEVC and other video coding standards, a video sequence typically includes a series of pictures. Pictures may also be referred to as “flames.” A picture may include three sample arrays, denoted S_{L}, S_{Cb} and S_{Cr}. S_{L} is a two-dimensional array (i.e., a block) of luma samples. S_{Cb} is a two-dimensional array of Cb chrominance samples. S_{Cr} is a two-dimensional array of Cr chrominance samples. Chrominance samples may also be referred to herein as “chroma” samples. In other instances, a picture may be monochrome and may only include an array of luma samples.

To generate an encoded representation of a picture, video encoder 20 may generate a set of coding tree units (CTUs). Each of the CTUs may be a coding tree block of luma samples, two corresponding coding tree blocks of chroma samples, and syntax structures used to code the samples of the coding tree blocks. A coding tree block may be an N×N block of samples. A CTU may also be referred to as a “tree block” or a “largest coding unit” (LCU). The CTUs of HEVC may be broadly analogous to the macroblocks of other standards, such as H.264/AVC. However, a CTU is not necessarily limited to a particular size and may include one or more coding units (CUs). In monochrome pictures or pictures having three separate color components, a CU may comprise a single coding block and syntax structures used to code the samples of the coding block. A slice may include an integer number of CTUs ordered consecutively in the raster scan.

To generate a coded CTU, video encoder 20 may recursively perform quad-tree partitioning on the coding tree blocks of a CTU to divide the coding tree blocks into coding blocks, hence the name “coding tree units.” A coding block is an N×N block of samples. A CU may be a coding block of luma samples and two corresponding coding blocks of chroma samples of a picture that has a luma sample array, a Cb sample array and a Cr sample array, and syntax structures used to code the samples of the coding blocks. Video encoder 20 may partition a coding block of a CU into one or more prediction blocks. A prediction block may be a rectangular (i.e., square or non-square) block of samples on which the same prediction is applied. A prediction unit (PU) of a CU may be a prediction block of luma samples, two corresponding prediction blocks of chroma samples of a picture, and syntax structures used to predict the prediction block samples. Video encoder 20 may generate predictive luma, Cb and Cr blocks for luma, Cb and Cr prediction blocks of each PU of the CU. In monochrome pictures or pictures having three separate color components, a PU may comprise a single prediction block and syntax structures used to predict the prediction block.

Video encoder 20 may use intra prediction or inter prediction to generate the predictive blocks for a PU. If video encoder 20 uses intra prediction to generate the predictive blocks of a PU, video encoder 20 may generate the predictive blocks of the PU based on decoded samples of the picture associated with the PU.

If video encoder 20 uses inter prediction to generate the predictive blocks of a PU, video encoder 20 may generate the predictive blocks of the PU based on decoded samples of one or more pictures other than the picture associated with the PU. Video encoder 20 may use uni-prediction or bi-prediction to generate the predictive blocks of a PU. When video encoder 20 uses uni-prediction to generate the predictive blocks for a PU, the PU may have a single motion vector (MV). When video encoder 20 uses bi-prediction to generate the predictive blocks for a PU, the PU may have two MVs.

After video encoder 20 generates predictive luma, Cb and Cr blocks for one or more PUs of a CU, video encoder 20 may generate a luma residual block for the CU. Each sample in the CU's luma residual block indicates a difference between a luma sample in one of the CU's predictive luma blocks and a corresponding sample in the CU's original luma coding block. In addition, video encoder 20 may generate a Cb residual block for the CU. Each sample in the CU's Cb residual block may indicate a difference between a Cb sample in one of the CU's predictive Cb blocks and a corresponding sample in the CU's original Cb coding block. Video encoder 20 may also generate a Cr residual block for the CU. Each sample in the CU's Cr residual block may indicate a difference between a Cr sample in one of the CU's predictive Cr blocks and a corresponding sample in the CU's original Cr coding block.

Furthermore, video encoder 20 may use quad-tree partitioning to decompose the luma, Cb and Cr residual blocks of a CU into one or more luma, Cb and Cr transform blocks. A transform block may be a rectangular block of samples on which the same transform is applied. A transform unit (TU) of a CU may be a transform block of luma samples, two corresponding transform blocks of chroma samples, and syntax structures used to transform the transform block samples. Thus, each TU of a CU may be associated with a luma transform block, a Cb transform block, and a Cr transform block. The luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color components, a TU may comprise a single transform block and syntax structures used to transform the samples of the transform block.

Video encoder 20 may apply one Of more transforms to a luma transform block of a TU to generate a luma coefficient block for the TU. A coefficient block may be a two-dimensional array of transform coefficients. A transform coefficient may be a scalar quantity. Video encoder 20 may apply one or more transforms to a Cb transform block of a TU to generate a Cb coefficient block for the TU. Video encoder 20 may apply one or more transforms to a Cr transform block of a TU to generate a Cr coefficient block for the TU.

After generating a coefficient block (e.g., a luma coefficient block, a Cb coefficient block or a Cr coefficient block), video encoder 20 may quantize the coefficient block. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, video encoder 20 may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

The term “block” may refer to any of the coding, prediction, transform, residual, or other blocks, for any one or more color components, described herein, in the context of HEVC, or similar data structures in the context of other standards (e.g., macroblocks and sub-blocks thereof in H.264/AVC). In this disclosure, “N×N” and “N by N” may be used interchangeably to refer to the pixel dimensions of a video block in terms of vertical and horizontal dimensions. e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Video encoder 20 may include in the encoded video bitstream, addition to the encoded video data, syntax elements that inform video decoder how to decode a particular block of video data, or grouping thereof. Video encoder 20 may include the syntax elements in a variety of syntax structures, e.g., depending on the type of video structure (e.g., sequence, picture, slice, block) to which it refers, and how frequently its value may change. For example, video encoder 20 may include syntax elements in parameter sets, such as a Video Parameter Set (VPS), Sequence Parameter Set (SPS), or Picture Parameter Set (PPS). As other examples, video encoder 20 may include syntax elements in SEI messages, picture headers, block headers, and slice headers.

In general, video decoder 30 may perform a decoding process that is the inverse of the encoding process performed by video encoder. For example, video decoder 30 may perform entropy decoding using the inverse of the entropy encoding techniques used by video encoder to entropy encode the quantized video data. Video decoder 30 may further inverse quantize the video data using the inverse of the quantization techniques employed by video encoder 20, and may perform an inverse of the transformation used by video encoder 20 to produce the transform coefficients that quantized. Video decoder 30 may then apply the resulting residual blocks to adjacent reference video data (intra-prediction), or predictive blocks from another picture (inter-prediction) to produce the video block for eventual display. Video decoder 30 may be configured, instructed, controlled or directed to perform the inverse of the various processes performed by video encoder 20 based on the syntax elements provided by video encoder 20 with the encoded video data in the bitstream received by video decoder 30.

Each picture may comprise a luma component and one or more chroma components. Accordingly, the block-based encoding and decoding operations described herein may be equally applicable to blocks including or associated with luma or chroma pixel values.

As noted above, intra-prediction includes predicting a PU of a current CU of a picture from previously coded CUs of the same picture. More specifically, a video coder may intra-predict a current CU of a picture taking a particular intra-prediction mode. A video coder may be configured with up to thirty-three directional intra-prediction modes, including a horizontal mode and a vertical mode, and two non-directional intra prediction modes, i.e., a DC mode and a planar mode.

The horizontal intra-prediction mode uses data from a left-side boundary of the current block, e.g., CU, to form a predicted block for the current block. The vertical intra-prediction mode uses data from a top-side boundary of the current block to form the predicted block. For non-directional intra-prediction modes, such as DC and planar modes, data from both the top-side boundary and the left-side boundary may be used to form the predicted block.

After intra-predicting a block using data of one (or both) of the left-side boundary and the top-side boundary, video encoder 20 and video decoder 30 may determine whether to boundary filter the predicted block using data of the other (or both) of the left-side boundary and the top-side boundary. For example, after forming a predicted block using data of a left-side boundary of a current block according to a horizontal intra-prediction mode, video encoder 20 and video decoder 30 may filter the predicted block using data of a top-side boundary. As another example, after forming a predicted block using data of a top-side boundary of a current block using a vertical prediction mode, video encoder 20 and video decoder 30 may filter the predicted block using data of a left-side boundary. Additionally, after forming a predicted block using data of the top-side boundary and the left-side boundary of a current block using a DC or planar intra prediction mode, video encoder 20 and video decoder 30 may filter the predicted block using data of the top-side boundary and the left-side boundary.

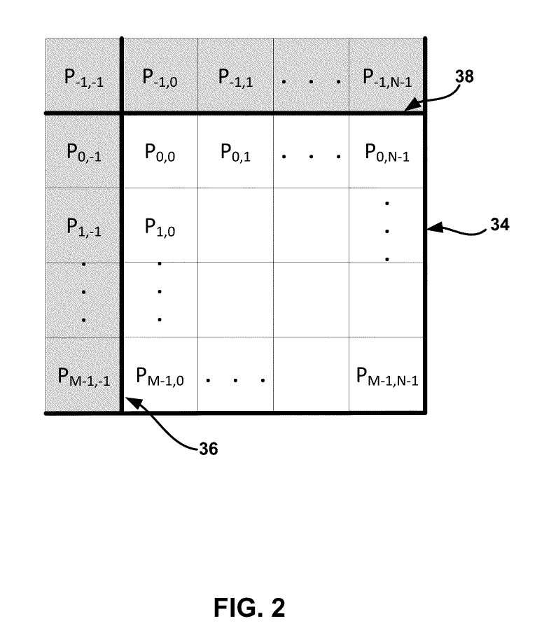

FIG. 2 is a conceptual diagram illustrating boundary filtering of a predicted block for a current video block 34 of size M (height)×N (width), based on neighboring samples (or pixels) of the current video block. Current video block 34 includes samples at positions designated Pᵢⱼ, 0≦i≦(M−1), 0≦j≦(N−1) in FIG. 2. The neighboring samples are shaded in FIG. 2, and neighbor current video block 34 at one or both of left-side boundary 36 and top-side boundary 38. In the example of FIG. 2 the neighboring samples that may be used for boundary filtering are denoted by P₋₁ⱼ, −1≦j≦(N−1) and P_{i,-1}, 0≦i≦(M−1).

In general, boundary filtering involves modifying samples of an intra predicted block for current block 34 using neighboring samples at one or more of boundaries 36 and 38. For example, after forming a predicted block for current block 34 using samples to the left of left-side boundary 36 according to a horizontal intra-prediction mode, video encoder 20 and video decoder 30 may filter the predicted block using neighboring samples of top-side boundary 38, e.g., samples at P₋₁ⱼ, −1≦j≦(N−1). As another example, after forming a predicted block for current block 34 using samples above top-side boundary 38 according to a vertical intra-prediction mode, video encoder 20 and video decoder 30 may filter the predicted block using neighboring samples of left-side boundary 36, e.g., samples at P_{i,-1}, −1≦i≦(M−1). Additionally, after forming a predicted block for current block 34 using neighboring samples above top-side boundary 38 and to the left of left-side boundary 36 using a DC or planar intra prediction mode, video encoder 20 and video decoder 30 may filter the predicted block using neighboring samples of left-side boundary 36 and top-side boundary 38, e.g., samples at P_{-i, -1}, 0≦i≦(M−1), and P_{-i,j,} 0≦j≦(N−1).

To boundary filter a predicted block, video encoder 20 and video decoder 30 may mathematically apply the values of the one or more neighboring samples to modify values of one or more samples of the predicted block. In some examples, video encoder 20 and video decoder 30 only modify samples of the predicted block adjacent to the neighboring samples, e.g., the left-most or first column (P_{i,0}, 0 ≦i≦(M−1)) and/or top-most or first row of samples (P_{0,j}, 0≦j≦(N−1)). As one example of boundary filtering, to determine each modified sample of the predicted block, video encoder 20 and video decoder 30 may compute an offset based on a weighted difference between two particular pixel values at the secondary boundary. The offset can be added to the pixel value in the predicted block to produce a modified pixel value. As one example, to determine a modified value at P_{0,0} for a predicted block determined according to a vertical intra prediction mode, video encoder 20 and video decoder 30 may compute an offset based on a weighted difference between the neighboring samples as P_{-1,-1} and P_{0,-1} using the following equation.

P_{0,0}=P_{0,0}+(P_{0,-1}−P_{-1,-1})/2 (1)

Video encoder 20 and video decoder 30 may also code the intra-predicted block, whether or not the predicted block was boundary filtered. That is, if the predicted block was not boundary filtered, video encoder 20 and video decoder 30 may code the block using the predicted block. In particular, video encoder 20 may calculate residual values, representing pixel-by-pixel differences between the predicted block and the original block, then code (e.g., transform, quantize, and entropy encode) the residual values. Video decoder 30, likewise, may decode residual values (e.g., entropy decode, inverse quantize and inverse transform) and combine the residual values with the predicted block to reconstruct the block.

On the other hand, if the predicted block was boundary filtered, video encoder 20 and video decoder 30 may code the block using the filtered predicted block. In particular, video encoder 20 may calculate residual values, representing pixel-by-pixel differences between the filtered predicted block and the original block, then code (e.g., transform, quantize, and entropy encode) the residual values. Video decoder 30, likewise, may decode residual values (e.g., entropy decode, inverse quantize and inverse transform) and combine the residual values with the filtered predicted block to reconstruct the block.

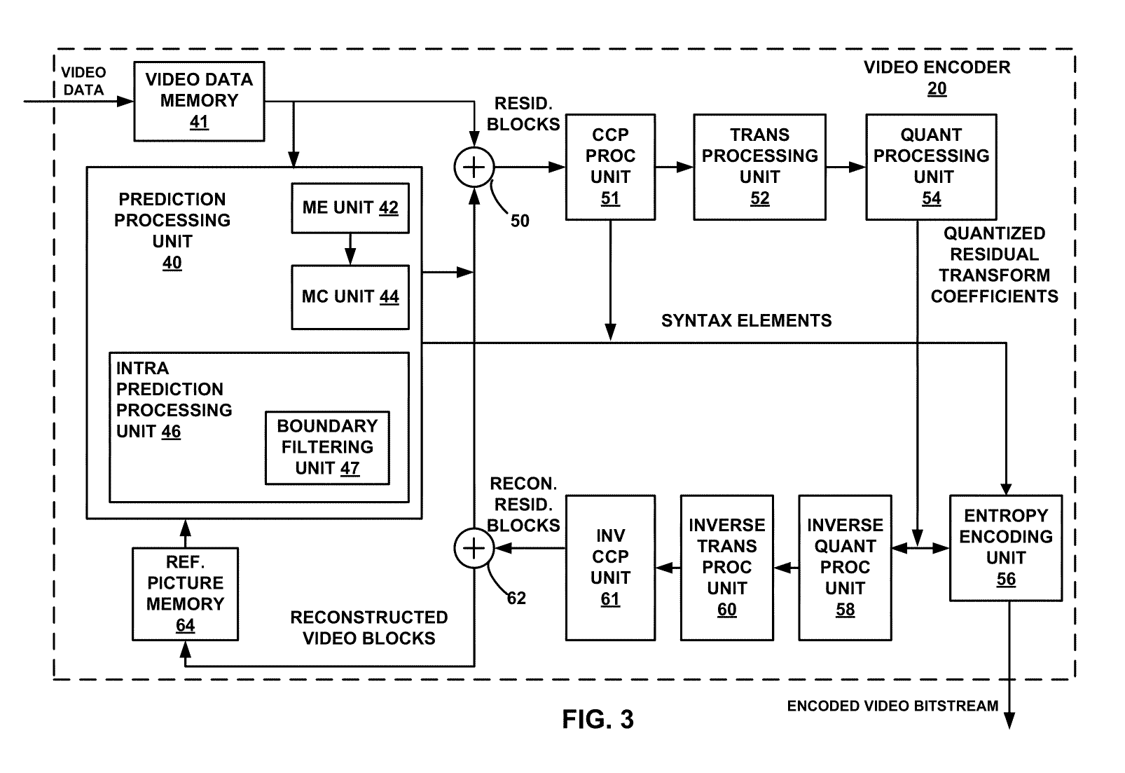

FIG. 3 is a block diagram illustrating an example of video encoder 20 that may implement techniques of this disclosure for boundary filtering and CCP, as will be explained in more detail below. Video encoder 20 will be described in the context of HEVC coding for purposes of illustration, but without limitation of this disclosure as to other coding standards. Moreover, video encoder 20 may be configured to implement techniques in accordance with the RExt or SCC extensions to HEVC.

Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 3, video encoder 20 receives video data, e.g., a current video block within a video frame to be encoded. In the example of FIG. 3, video encoder 20 includes a video data memory 41, a prediction processing unit 40, reference picture memory 64, summer 50, CCP processing unit 51, transform processing unit 52, quantization processing unit 54, and entropy encoding unit 56. Prediction processing unit, in turn, includes motion estimation (ME) unit 42, motion compensation (MC) unit 44, and intra-prediction processing unit 46. Intra-prediction processing unit 46 includes boundary filtering unit 47. For video block reconstruction, video encoder 20 also includes inverse quantization processing unit 58, inverse transform unit 60, inverse CCP processing unit 61 and summer 62.

A deblocking filter (not shown in FIG. 3) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter). Example filters may include adaptive loop filters, sample adaptive offset (SAO) filters or other types of filters.

Video data memory 41 may store video data to be encoded by the components of video encoder 20. The video data stored in video data memory 41 may be obtained, for example, from video source 18. Reference picture memory 64 may store reference video data for use in encoding video data by video encoder 20, e.g., in intra- or inter-coding modes. Video data memory 41 and reference picture memory 64 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 41 and decoded picture buffer 64 may be provided by the same memory device or separate memory devices. In various examples, video data memory 41 may be on-chip with other components of video encoder 20, or off-chip relative to those components.

Video encoder 20 may receive video data. Video encoder 20 may encode each CTU in a slice of a picture of the video data. Each of the CTUs may be associated with equally-sized luma coding tree blocks (CTBs) and corresponding CTBs of the picture. As part of encoding a CTU, block encoding unit 100 may perform quad-tree partitioning to divide the CTBs of the CTU into progressively-smaller blocks. The smaller block may be coding blocks of CUs. For example, block encoding unit 100 may partition a CTB associated with a CTU into four equally-sized sub-blocks, partition one or more of the sub-blocks into four equally-sized sub-sub-blocks, and so on.

Video encoder 20 may encode CUs of a CTU to generate encoded representations of the CUs (i.e., coded CUs). As part of encoding a CU, prediction processing unit 40 may partition the coding blocks associated with the CU among one or more PUs of the CU. Thus, each PU may be associated with a luma prediction block and corresponding chroma prediction blocks. Video encoder 20 and video decoder 30 may support PUs having various sizes. As indicated above, the size of a CU may refer to the size of the luma coding block of the CU and the size of a PU may refer to the size of a luma prediction block of the PU. Assuming that the size of a particular CU is 2N×2N, video encoder 20 and video decoder 30 may support PU sizes of 2N×2N or N×N for intra prediction, and symmetric PU sizes of 2N×2N, 2N×N, N×2N, N×N, or similar for inter prediction. Video encoder 20 and video decoder 30 may also support asymmetric partitioning for PU sizes of 2N×nU, 2N×nD, nL×2N, and nR×2N for inter prediction.

Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, prediction processing unit 40 may partition blocks of video data into sub-blocks, based on evaluation of previous partitioning schemes in previous coding passes. Prediction processing unit 40 may select one of the coding modes, intra or inter, e.g., based on error results, and provides the resulting intra- or inter-coded block to summer 50 to generate residual block data and to summer 62 to reconstruct the encoded block for use as a reference frame. Prediction processing unit 40 also provides syntax elements, such as motion vectors, intra-mode indicators, partition information, and other syntax information, e.g., described herein, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit).

A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Prediction processing unit 40 may also generate syntax elements associated with the video blocks and the video slice for use by video decoder 30 in decoding the video blocks of the video slice.

Intra-prediction processing unit 46 may intra-predict a current block, as an alternative to the inter-prediction performed by motion estimation unit 42 and motion compensation unit 44, as described above. In particular, intra-prediction processing unit 46 may determine an intra-prediction mode to use to encode a current block. In some examples, intra-prediction processing unit 46 may encode a current block using various intra-prediction modes, e.g., during separate encoding passes, and intra-prediction processing unit 46 (or prediction processing unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction processing unit 46 may calculate ratios from the distortions and rates for the various encoded blocks to determine which intra-prediction mode exhibits the best rate-distortion value for the block.

Boundary filtering unit 47 may boundary filter a predicted block generated by intra prediction processing unit 46 for a current video block using any of the techniques described herein, e.g., with reference to FIG. 2. For example, boundary filtering unit 47 may modify sample or pixel values of a first row and/or a first column of the predicted block based on neighboring values at left-side boundary 36 and/or top-side boundary 38. Boundary filtering unit 47 may access reconstructed neighboring blocks from reference picture memory 64 to determine the values of the neighboring samples for the current video block.

In some examples, boundary filtering unit 47 (or intra prediction processing unit 46) determines that a block of a first component, e.g., luma component, of the video data is intra-predicted using one of a DC mode, a horizontal mode, or a vertical mode, and determines that a corresponding block of a second component, e.g., chroma component, of the video data is intra-predicted using the same mode as the block of the first component according to a direct mode (DM) to form a predicted block for the second component. In such examples, boundary filtering unit 47 may boundary filter the predicted block in response to the determinations. Summer 50 may subtract a predicted block, which may have been boundary filtered, from the current block to produce a residual block.

In some examples, boundary filtering unit 47 (or intra prediction processing unit 46) further determines that CCP processing unit 51 uses CCP to predict a residual for the corresponding block of the second component based on a residual for the block of the first component. In such examples, boundary filtering unit 47 boundary filters the predicted block for the second component in response to the determinations that the block of the first component of the video data is intra-predicted using one of a DC mode, a horizontal mode, or a vertical mode, that a corresponding block of a second component of the video data is intra-predicted using the same mode as the block of the first component according to a direct mode, and that cross-component prediction (CCP) is used to predict the residual for the corresponding block of the second component based on the residual for the block of the first component. In some examples, intra prediction processing unit 46 (or prediction processing unit 40) generates a syntax element, e.g., a flag, for encoding by entropy encoding unit 56, with a value that indicates whether or not the predicted block is boundary filtered in response to the determinations.

CCP processing unit 51 may be an adaptively switched predictor unit that codes the residuals of a second and third color component using the residual of the first color component. In one example approach, in the case of YC_{b}Cᵣ, the residual of the luma (Y) luma component is used to code the residuals of the two chroma (C_{b}, Cᵣ) components. In another example approach, the residual of the green (G) channel of RGB is used to code the residuals of the red (R) and blue (B) channels. In some examples, CCP processing unit 51 determines a predictor for the residual blocks for the second (and third) color components as a function of the residual block of the first color component. As an example, the function may be in the form αγ+β, where γ is a residual value of the first component, α is a scale factor, and β is an offset. In some examples in which boundary filtering unit 47 does not, e.g., is not configured to, boundary filter the predicted block for the second component, e.g., chroma component, CCP processing unit 51 may determine that a predicted block of a first component of the video data was boundary filtered, and inverse cross-component predict the residual block, excluding the first column and the first row of the residual block, based on the determination.

Transform processing unit 52 applies the transform to the residual block, producing a block of residual transform coefficients. The transform may convert the residual information from a pixel value domain to a transform domain, such as a frequency domain. Transform processing unit 52 may perform transforms such as discrete cosine transforms (DCTs) or other transforms that are conceptually similar to DCT. Wavelet transforms, integer transforms, sub-band transforms or other types of transforms could also be used. Transform processing unit 52 may send the resulting transform coefficients to quantization processing unit 54. In some examples, the transform process may be skipped.

Quantization processing unit 54 quantizes the transform coefficients to further reduce bit rate. The quantization process may reduce the bit depth associated with some or all of the coefficients. The degree of quantization may be modified by adjusting a quantization parameter. In some examples, quantization processing unit 54 may then perform a scan of the matrix including the quantized transform coefficients. Alternatively, entropy encoding unit 56 may perform the scan.

Following quantization, entropy encoding unit 56 entropy codes the quantized transform coefficients, and any other syntax elements related to the prediction and coding of the video block. For example, entropy encoding unit 56 may perform context adaptive binary arithmetic coding (CABAC) or other entropy coding processes, such as context adaptive variable length coding (CAVLC), syntax-based context-adaptive binary arithmetic coding (SBAC), or probability interval partitioning entropy (PIPE) coding. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization processing unit 58, inverse transform processing unit 60, and inverse CCP processing unit 61 apply inverse quantization, inverse transformation and inverse cross-component prediction processing, respectively, to reconstruct the residual block in the pixel domain, e.g., for later combination with the predicted block, and use of the reconstructed block as a reference block. Motion compensation unit 44 may calculate a reference block by adding the residual block to a predictive block of one of the frames of reference picture memory 64. Motion compensation unit 44 may also apply one or more interpolation fitters to the reconstructed block to calculate sub-integer pixel values for use in motion estimation.

Summer 62 adds the reconstructed residual block to the motion compensated prediction block produced by motion compensation unit 44 to produce a reconstructed video block for storage in reference picture memory 64. The reconstructed video block may be used by motion estimation unit 42 and motion compensation unit 44 as a reference block to inter-code a block in a subsequent video frame.

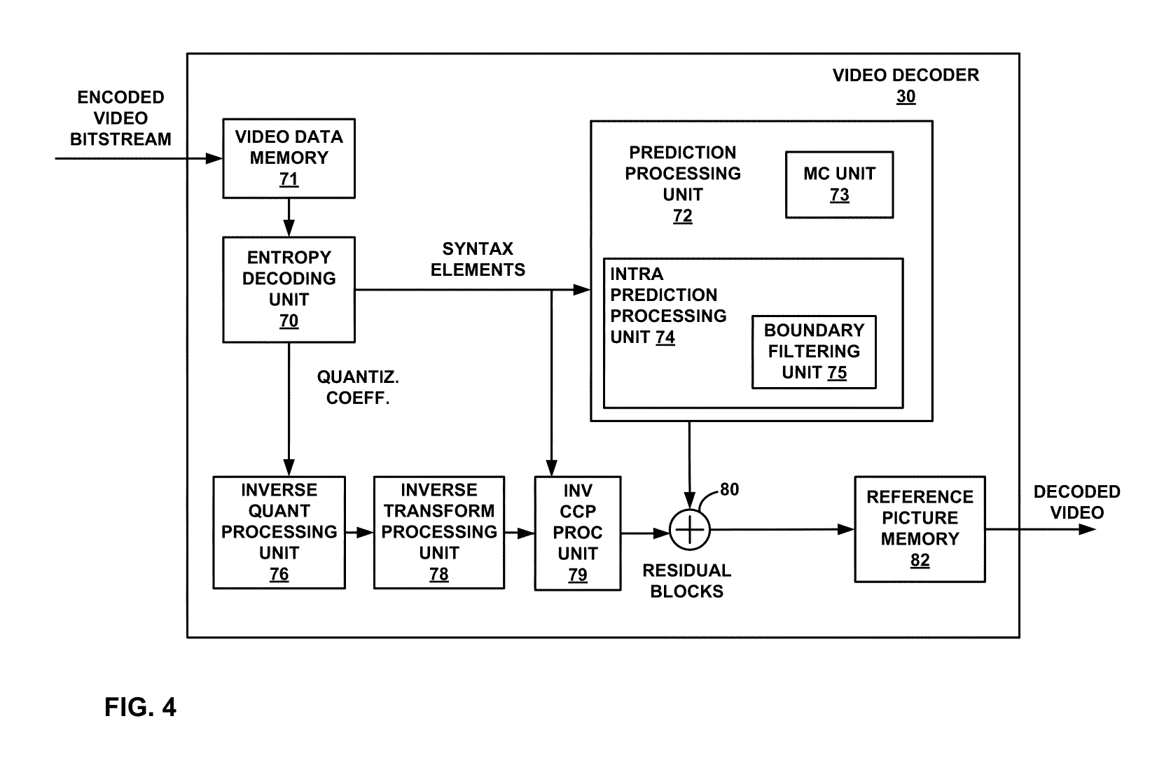

FIG. 4 is a block diagram illustrating an example of video decoder 30 that may implement techniques for boundary filtering and cross-component prediction. Again, the video decoder 30 will be described in the context of HEVC coding for purposes of illustration, but without limitation of this disclosure as to other coding standards. Moreover, video decoder 30 may be configured to implement techniques in accordance with the RExt or SCC extensions.

In the example of FIG. 4, video decoder 30 includes a video data memory 71, an entropy decoding unit 70, prediction processing unit 72, inverse quantization processing unit 76, inverse transformation processing unit 78, inverse CCP processing unit 79, reference picture memory 82, and summer 80. In the example of FIG. 4, prediction processing unit 72 includes motion compensation (MC) unit 73 and intra prediction processing unit 74. Intra prediction processing unit 74 includes boundary filtering unit 75.

Video data memory 71 may store video data, such as an encoded video bitstream, to be decoded by the components of video decoder 30. The video data stored in video data memory 71 may be obtained, for example, from a computer-readable medium, e.g., from a local video source, such as a camera, via wired or wireless network communication of video data, or by accessing physical data storage media. Video data memory 71 may store encoded video data from an encoded video bitstream. Reference picture memory 82 stores reference video data that has been previously decoded for use in decoding video data by video decoder 30, e.g., in intra- or inter-coding modes. Video data memory 71 and reference picture memory 82 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 71 and reference picture memory 82 may be provided by the same memory device or separate memory devices. In various examples, video data memory 71 may be on-chip with other components of video decoder 30, or off-chip relative to those components.

During the decoding process, video decoder 30 receives an encoded video bitstream that represents video blocks of an encoded video slice and associated syntax elements from video encoder 20. Entropy decoding unit 70 entropy decodes the bitstream to generate quantized coefficients, motion vectors or intra-prediction mode indicators, and other syntax elements. Video decoder 30 may receive the syntax elements at the video slice level and/or the video block level.

Prediction processing unit 72 may determine whether a given slice or video block is intra-coded or inter-coded, e.g., based on syntax information decoded from encoded video bitstream by entropy decoding unit 70. When a block is intra-coded, intra-prediction processing unit 74 may generate a predicted block for the current video block based on a signaled intra prediction mode and data from previously decoded blocks of the current frame or picture. Boundary filtering unit 75 may boundary filter a predicted block generated by intra prediction processing unit 74 for a current video block using any of the techniques described herein, e.g., with reference to FIG. 2. For example, boundary filtering unit 75 may modify sample or pixel values of a first row and/or a first column of the predicted block based on neighboring values at left-side boundary 36 and/or top-side boundary 38. Boundary filtering unit 75 may access reconstructed neighboring blocks from reference picture memory 82 to determine the values of the neighboring samples for the current video block.

In some examples, boundary filtering unit 75 (or intra prediction processing unit 74) determines that a block of a first component, e.g., luma component, of the video data is intra-predicted using one of a DC mode, a horizontal mode, or a vertical mode, and determines that a corresponding block of a second component, e.g., chroma component, of the video data is intra-predicted using the same mode as the block of the first component according to a direct mode to form a predicted block for the second component. In such examples, boundary filtering unit 75 may boundary filter the predicted block of the second component in response to the determinations.

In some examples, boundary filtering unit 75 (or intra prediction processing unit 74) further determines that inverse CCP processing unit 79 uses CCP to predict a residual for the corresponding block of the second component based on a residual for the block of the first component. In such examples, boundary filtering unit 47 boundary filters the predicted block for the second component in response to the determinations that the block of the first component of the video data is intra-predicted using one of a DC mode, a horizontal mode, or a vertical mode, that a corresponding block of a second component of the video data is intra-predicted using the same mode as the block of the first component according to a direct mode, and that cross-component prediction is used to predict the residual for the corresponding block of the second component based on the residual for the block of the first component. In some examples, intra prediction processing unit 74 (or prediction processing unit 72) receives a syntax element, e.g., flag, decoded by entropy decoding unit 70 that indicates whether or not the predicted block is boundary filtered in response to the above-discussed determinations. If the syntax element indicates that the predicted block for the second component is boundary filtered

When a block is inter-coded, motion compensation unit 73 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference picture memory 82.

Motion compensation unit 73 determines prediction information for a video block of the current video slice by parsing the motion vectors and other syntax elements, and uses the prediction information to produce the predictive blocks for the current video block being decoded. For example, motion compensation unit 73 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter encoded video block of the slice, inter-prediction status for each inter-coded video block of the slice, and other information to decode the video blocks in the current video slice.

Motion compensation unit 73 may also perform interpolation based on interpolation filters. Motion compensation unit 73 may use interpolation filters as used by video encoder 20 during encoding of the video blocks to calculate interpolated values for sub-integer pixels of reference blocks. In this case, motion compensation unit 73 may determine the interpolation filters used by video encoder 20 from the received syntax elements and use the interpolation filters to produce predictive blocks.

Inverse quantization processing unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied. Inverse transform processing unit 78 applies an inverse transform, e.g., an inverse DCT, an inverse integer transform, or a conceptually similar inverse transform process, to the transform coefficients in order to produce residual blocks in the pixel domain.

If video encoder 20 used CCP to predict the residuals of the second and third color components, inverse CCP processing unit 79 receives coded or predicted residuals of the second and third color components, e.g., from inverse transform processing unit 78. Inverse CCP processing unit 79 reconstructs the residuals of the second and third color components as a function of the coded residuals and the residual of the first color component, e.g., according to the inverse of the function described above with respect to FIG. 3.

In the case of YC_{b}Cᵣ, the luma (Y) component may be used, for example, as the first component and, in that case, the residual of the luma component is used by inverse CCP processing unit 79 to reconstruct the residuals of the two chroma. (C_{b}, Cᵣ) components. Likewise, in the case of RGB, the green (G) component may be used, for example, as the first component and, in that case, the residual of the green component is used by inverse CCP processing unit 79 to reconstruct the residuals of the red (R) and blue (B) components. In some examples in which boundary filtering unit 75 does not, e.g., is not configured to, boundary filter the predicted block for the second and third components, e.g., chroma components, video encoder 20 does not use CCP to predict the first row and first column of the residual block for the second and third components when the predicted block for the first component is boundary filtered. In such examples, inverse CCP processing unit 79 may determine whether a predicted block of a first component of the video data was boundary filtered, and inverse cross-component predict the residual block, excluding the first column and the first row of the residual block, based on the determination.

After motion compensation unit 73 or intra-prediction unit 74 generates the predictive block for the current video block based on motion vectors or other syntax elements, video decoder 30 forms a decoded video block by summing the residual blocks from inverse transform processing unit 78 or inverse cross-component prediction processing unit 79 with the corresponding predictive blocks generated by motion compensation unit 73 or intra-prediction unit 74. Summer 80 represents the component or components that perform this summation operation.

If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 82, which stores reference pictures used for subsequent motion compensation. Reference picture memory 82 also stores decoded video for later presentation on a display device, such as display device 32 of FIG. 1.

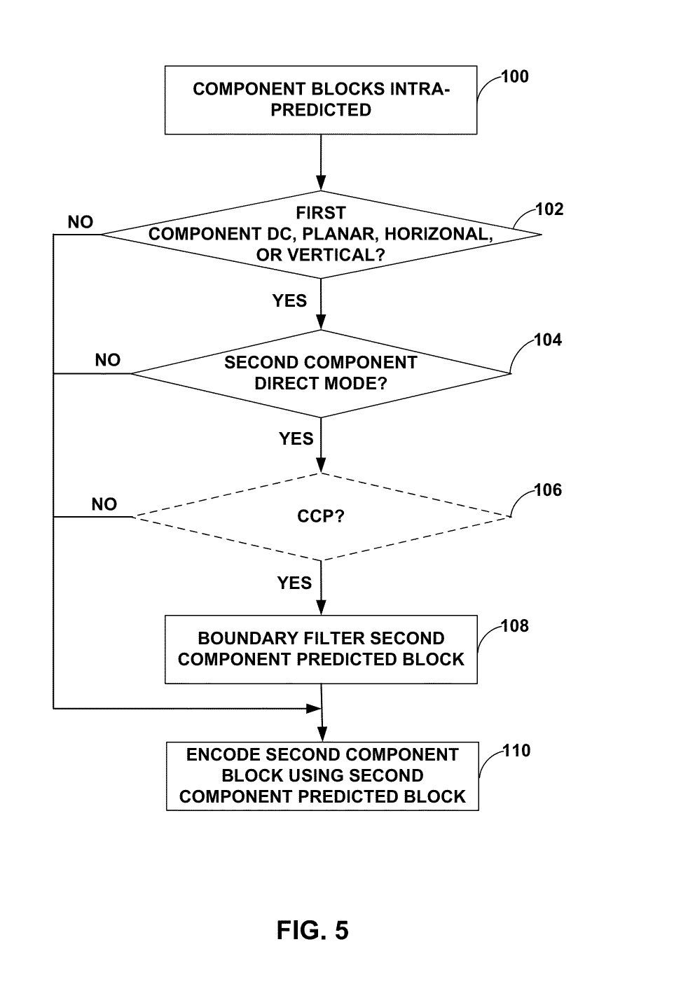

FIG. 5 is a flow diagram illustrating an example technique for boundary filtering a predicted block of a second component that may be implemented by a video encoder, such as video encoder 20 that includes intra-prediction processing unit 46, boundary filtering unit 47, CCP processing unit 51, and inverse CCP processing unit 61.

According to the example of FIG. 5, intra-prediction processing unit 46 and/or boundary filtering unit 47 of video encoder 20 determines that the color component blocks for a current video block are intra predicted (100), and determines whether the block of the first component, e.g., luma component, is intra predicted using one of the DC, planar, horizontal, or vertical intra prediction modes (102). If the block of the first component is intra predicted using one of the indicated modes (YES of 102), intra-prediction processing unit 46 and/or boundary filtering unit 47 further determines whether the second component block, e.g., chroma block, is intra predicted using the same mode as the first block according to the direct mode (104).

In some examples, if the block of the first component is intra predicted using one of the indicated modes and the second component block is intra predicted using the same mode as the first block according to the direct mode (YES of 104), boundary filtering unit 47 boundary filters a predicted block for the second component (108). In some examples, intra-prediction processing unit 46 and/or boundary filtering unit 47 further determines whether CCP will be applied by CCP processing unit 51 to predict the residual block of the second component (106), and boundary filtering unit 47 boundary filters a predicted block for the second component (108) in response to the block of the first component being intra predicted using one of the indicated modes, the second component block being intra predicted using the same mode as the first block according to the direct mode, and CCP being applied to the residual block for the second component (YES of 106). Video encoder 20 encodes the second component block using the second component predicted block (110), whether boundary filtered (108), or not boundary filtered (NO of 102, 104, or 106).

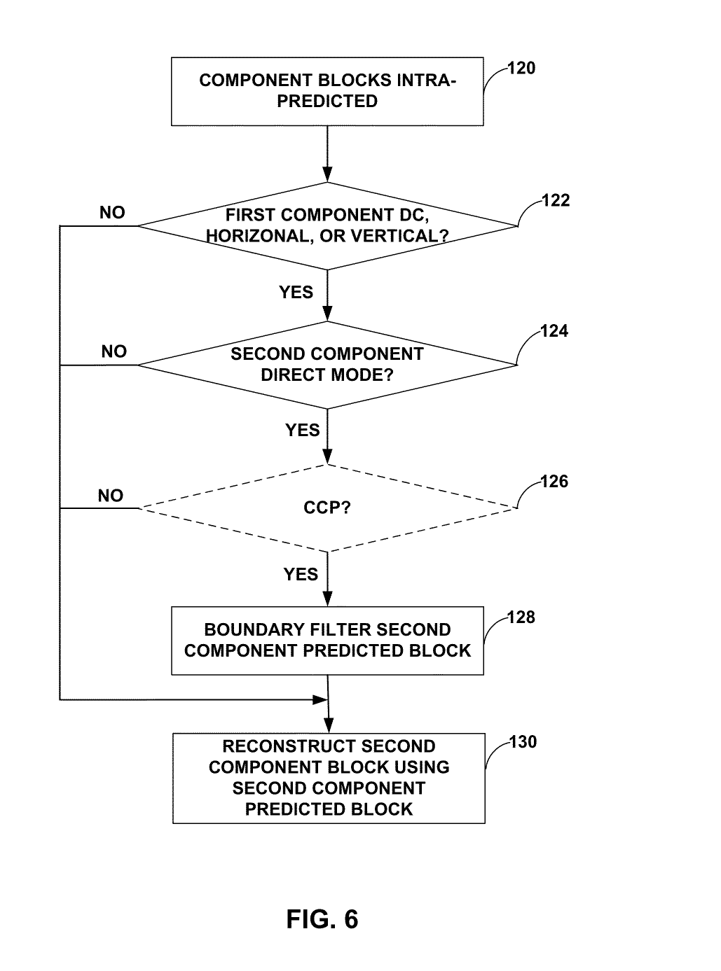

FIG. 6 is a flow diagram illustrating an example technique for boundary filtering a predicted block of a second component that may be implemented by a video decoder, such as video decoder 30 that includes intra-prediction processing unit 74, boundary filtering unit 47, and inverse CCP processing unit 79.

According to the example of FIG. 6, intra-prediction processing unit 74 and/or boundary filtering unit 75 of video decoder 30 determines that the color component blocks for a current video block are intra predicted (120), and determines whether the block of the first component, e.g., luma component, is intra predicted using one of the DC, planar, horizontal, or vertical intra prediction modes (122). If the block of the first component is intra predicted using one of the indicated modes (YES of 122), intra-prediction processing unit 74 and/or boundary filtering unit 75 further determines whether the second component block, e.g., chroma block, is intra predicted using the same mode as the first block according to the direct mode (124).

In some examples, if the block of the first component is intra predicted using one of the indicated modes and the second component block is intra predicted using the same mode as the first block according to the direct mode (YES of 124), boundary filtering unit 75 boundary filters a predicted block for the second component (128). In some examples, intra-prediction processing unit 74 and/or boundary filtering unit 75 further determines whether inverse CCP will be applied by inverse CCP processing unit 79 to reconstruct the residual block of the second component (126), and boundary filtering unit 75 boundary filters a predicted block for the second component (128) in response to the block of the first component being intra predicted using one of the indicated modes, the second component block being intra predicted using the same mode as the first block according to the direct mode, and CCP being applied to the residual block for the second component (YES of 126). Video decoder 30 reconstructs the second component block using the second component predicted block (130), whether boundary filtered (128), or not boundary filtered (NO of 122, 124, or 126).

In some examples, video encoder 20 encodes, and video decoder 30 decodes, syntax information that indicates whether a predicted block of a second component is boundary filtered, e.g., according to the example methods of FIGS. 5 and 6. In some examples, the syntax information comprises a flag, e.g., that enables the techniques for chroma boundary filtering described herein. In some examples, if the flag is 0, boundary filtering is applied only to the first, e.g., luma, component when the block is intra-coded and the intra prediction mode is DC, horizontal or vertical. This matches with the current HEVC, RExt and SCC specifications. In such examples, if the flag is 1, boundary filtering of the second, e.g., chroma, component, is enabled as described herein. The syntax information, e.g., flag, may be signaled from video encoder 20 to video decoder 30 in the VPS, SPS, PPS, slice header, LCU or CU. Likewise, video decoder 30 may receive the signaled syntax information, e.g., in in the VPS, SPS, PPS, slice header, LCU or CU.

A simulation according to the techniques disclosed herein was performed. In particular, boundary filtering was performed on predicted blocks for the second and third (e.g., chroma) components, if all of the following conditions were satisfied: (1) the current block is inter coded; and (2) the chroma intra prediction mode is DM and (3) the corresponding luma intra prediction mode is DC. The proposed scheme was implemented on SCC common software and tested using the common test condition defined in Yu et al., Common conditions for screen content coding tests,” Document: JCTVC-R1015, Joint Collaborative Team on Video Coding (JCT-VC) of ITU-T SG 16 WP 3 and ISO/IEC JTC 1/SC 29/WG 11, 18^{th} Meeting: Sapporo, Japan, June 2014. The simulation results report that the proposed method achieves 1.5% and 1.3% BD-rate savings for mixed content RGB 1440p and 1080P, respectively, against the SCM2.0 anchor in the full frame intra BC test condition. Table 1 demonstrates the coding performance with the proposed chroma boundary filter.

TABLE 1
Proposed chroma boundary filter based on DM mode

| | All Intra | | |
|---|---|---|---|
| | G/Y | B/U | R/V |
| RGB, text & graphics with motion, | −0.2% | −0.1% | −0.1% |
| 1080p | | | |
| RGB, text & graphics with motion, | −0.8% | −0.4% | −0.5% |
| 720p | | | |
| RGB, mixed content, 1440p | −1.5% | −0.9% | −1.0% |
| RGB, mixed content, 1080p | −1.3% | −0.9% | −0.8% |
| RGB, Animation, 720p | −0.5% | −0.3% | −0.4% |
| RGB, camera captured, 1080p | −0.4% | −0.4% | −0.4% |
| YUV, text & graphics with motion, | −0.1% | 0.0% | 0.0% |
| 1080p | | | |
| YUV, text & graphics with motion, | −0.1% | −0.1% | 0.0% |
| 720p | | | |
| YUV, mixed content, 1440p | −0.1% | −0.1% | 0.0% |
| YUV, mixed content, 1080p | −0.2% | −0.1% | 0.0% |
| YUV, Animation, 720p | −0.1% | −0.1% | 0.1% |
| YUV, camera captured, 1080p | −0.1% | 0.0% | −0.2% |

| | |
|---|---|
| Enc Time[%] | 96% |
| Dec Time[%] | 93% |

In other example techniques, which need not be applied with the example techniques of FIGS. 5 and 6, when the boundary filter is applied to the predicted block for the first component, and CCP is applied to predict the residual block for the second component, the boundary filter is not applied to the second or third component. However, CCP, e.g., the CCP reconstruction process, is modified. For example, CCP may not be applied to predict the values of the left-most column or top row (e.g., first column and first row) of the residual blocks for the second and third components. For the left-most column and the top row, the actual residue is coded, e.g., video decoder 30 directly uses the decoded residue as the reconstructed residue without CCP.

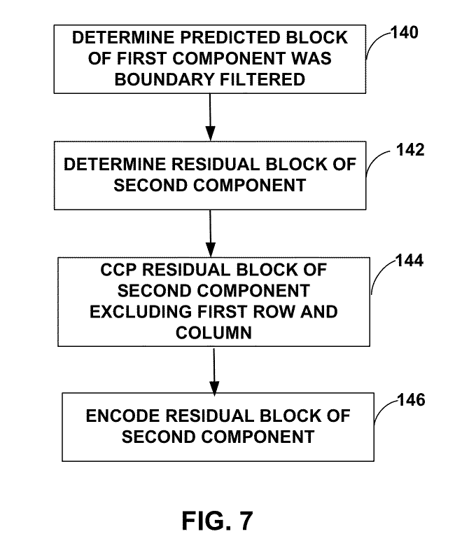

FIG. 7 is a flow diagram illustrating an example technique for cross-component prediction that may be implemented by a video encoder, such as video encoder 20 including CCP processing unit 51 and inverse CCP processing unit 61. The example technique of FIG. 7 need not be implemented with the example techniques of FIGS. 5 and 6.

According to the example of FIG. 7, CCP processing unit 51 determines whether the predicted block of the first component of a current video block was boundary filtered (140). Summer 50 generates a residual block for the second component of he current video block (142). Based on the determination that the predicted block of the first component was boundary filtered, CCP processing unit 51 (and inverse CCP processing unit 61) cross-component predicts the residual block for the second component, excluding the first (left-most) column and first (top) row, based on the residual for the first component (144). In other words, CCP processing unit 51 does not cross-component predict the first (left-most) column and first (top) row, but does cross-component predict the remaining values of the residual block. Entropy encoding unit 56 encodes the residual block of the second component, which was, excluding the first column and first row, predicted and encoded based on the residual for the first component (146). The residual block may have been transformed and quantized, e.g., by transform processing unit 52 and quantization processing unit 54.

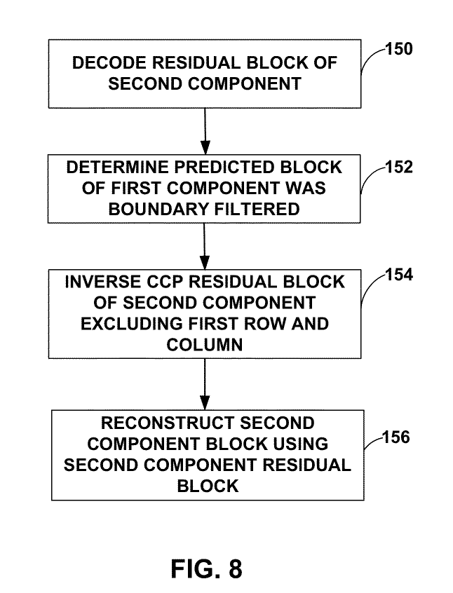

FIG. 8 is a flow diagram illustrating an example technique for cross-component prediction that may be implemented by a video decoder, such as video decoder 30, which includes an inverse CCP processing unit 79. The example technique of FIG. 8 need not be implemented with the example techniques of FIGS. 5 and 6.

According to the example of FIG. 8, entropy decoding unit 70 entropy decodes a residual block for the second component of a current video block (15 ), e.g., quantized transform coefficients are processed by inverse quantization processing unit 76 and inverse transform processing unit 78 to produce the residual block. Inverse CCP processing unit 79 determines that the predicted block for the first component of the current video block was boundary filtered (152). Based on the determination, inverse CCP processing unit 79 inverse cross-component predicts, and thereby reconstructs, the values of the residual block for the second component, excluding the first row and column, based on the residual block for the first component (154). Summer 80 reconstructs the second component block using the reconstructed residual block for the second component (156). Inverse CCP processing unit 79 does not inverse cross-component predict the values of the first row and column of the residual block for the second component. For the first row and column of the second component residual block, summer 80 uses the decoded residual values directly for reconstructing the second component block.

The techniques described above may be performed by video encoder 20 (FIGS. 1 and 2) and/or video decoder 30 (FIGS. 1 and 3), both of which may be generally referred to as a video coder. In addition, video coding may generally refer to video encoding and/or video decoding, as applicable. While the techniques of this disclosure are generally described with respect to range extension and screen content extension to HEVC, the techniques are not limited in this way. The techniques described above may also be applicable to other current standards or future standards not yet developed.

it should be understood that, depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially. In addition, while certain aspects of this disclosure are described as being performed by a single module or unit for purposes of clarity, it should be understood that the techniques of this disclosure may be performed by a combination of units or modules associated with a video coder.

While particular combinations of various aspects of the techniques are described above, these combinations are provided merely to illustrate examples of the techniques described in this disclosure. Accordingly, the techniques of this disclosure should not be limited to these example combinations and may encompass any conceivable combination of the various aspects of the techniques described in this disclosure.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include compute-readable storage media, which corresponds to a tangible medium such as data storage media, or communication media including any medium that facilitates transfer of a computer program from one place to another, e.g., according to a communication protocol.

In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable storage medium and packaging materials.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide vane devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various aspects of the disclosure have been described. These and other aspects are within the scope of the following claims.

What is claimed is:

1. A method of decoding video data, the method comprising:
determining that a block of a first component of the video data is intra-predicted using one of a DC mode, a horizontal mode, or a vertical mode;
determining that a corresponding block of a second component of the video data is intra-predicted using the same mode as the block of the first component according to a direct mode to form a predicted block for the second component;
boundary filtering the predicted block in response to the determinations; and
reconstructing the block of the second component using the boundary filtered predicted block.

2. The method of claim 1, further comprising determining that cross-component prediction is used to predict a residual for the corresponding block of the second component based on a residual for the block of the first component, wherein boundary filtering the predicted block in response to the determinations comprises boundary filtering the predicted block in response to the determination that cross-component prediction is used to predict the residual for the corresponding block of the second component based on the residual for the block of the first component.

3. The method of claim 1, wherein boundary filtering the predicted block comprises filtering at least one of a first row or a first column of the predicted block.

4. The method of claim 1, wherein the first component comprises a luma component, and the second component comprises a chroma component.

5. The method of claim 1, wherein the first component comprises one of a green component, a red component, or a blue component, and the second component comprises another of the green component, the red component, or the blue component.

6. The method of claim 1, further comprising decoding a syntax element, wherein the decoder determines whether to boundary filter the predicted block in response to the determinations based on syntax element.

7. The method of claim 1, wherein a color format for the video data is 4:4:4.

8. A method of encoding video data, the method comprising:
determining that a block of a first component of the video data is intra-predicted using one of a DC mode, a horizontal mode, or a vertical mode;
determining that a corresponding block of a second component of the video data is intra-predicted using the same mode as the block of the first component according to a direct mode to form a predicted block for the second component;
boundary filtering the predicted block in response to the determinations; and
encoding the block of the second component using the boundary filtered predicted block.

9. The method of claim 8, further comprising determining that cross-component prediction is used to predict a residual for the corresponding block of the second component based on a residual for the block of the first component, wherein boundary filtering the predicted block in response to the determinations comprises boundary filtering the predicted block in response to the determination that cross-component prediction is used to predict the residual for the corresponding block of the second component based on the residual for the block of the first component.

10. The method of claim 8, wherein boundary filtering the predicted block comprises filtering at least one of a first row or a first column of the predicted block.

11. The method of claim 8, wherein the first component comprises a luma component, and the second component comprises a chroma component.

12. The method of claim 8, wherein the first component comprises one of a green component, a red component, or a blue component, and the second component comprises another of the green component, the red component, or the blue component.

13. The method of claim 8, further comprising encoding a syntax element, wherein the syntax element indicates to a video decoder whether to boundary filter the predicted block in response to the determinations.

14. The method of claim 8, wherein a color format for the video data is 4:4:4.

15. A video decoding device comprising:
a memory configured to store video data; and
one or more processors connected to the memory, wherein the one or more processors are configured to:
determine that a block of a first component of the video data is intra-predicted using one of a DC mode, a horizontal mode, or a vertical mode;
determine that a corresponding block of a second component of the video data is intra-predicted using the same mode as the block of the first component according to a direct mode to form a predicted block for the second component;
boundary filter the predicted block in response to the determinations; and
reconstruct the block of the second component using the boundary filtered predicted block.

16. The device of claim 15, wherein the one or more processors are further configured to determine that cross-component prediction is used to predict a residual for the corresponding block of the second component based on a residual for the block of the first component, wherein the one or more processors are configured to boundary filter the predicted block in response to the determinations that the block of the first component is intra-predicted using one of the DC mode, the horizontal mode, or the vertical mode, the corresponding block of the second component is intra-predicted using the same mode as the block of the first component according to the direct mode, and cross-component prediction is used to predict the residual for the corresponding block of the second component based on the residual for the block of the first component.

17. The device of claim 15, wherein the one or more processors are configured to boundary filter at least one of a first row or a first column of the predicted block.

18. The device of claim 15, wherein the first component comprises a luma component, and the second component comprises a chroma component.

19. The device of claim 15, wherein the first component comprises one of a green component, a red component, or a blue component, and the second component comprises another of the green component, the red component, or the blue component.

20. The device of claim 15, wherein the one or more processors are further configured to decode a syntax element, and determine whether to boundary filter the predicted block in response to the determinations based on syntax element.

21. The device of claim 15, wherein the device comprises at least one of:
a microprocessor;
an integrated circuit (IC); or
a wireless communication device comprising the one or more processors.

22. The device of claim 15, further comprising a display configured to display the video data.

23. A video encoding device comprising:
a memory configured to store video data; and
one or more processors connected to the memory, wherein the one or more processors are configured to:
determine that a block of a first component of the video data is intra-predicted using one of a DC mode, a horizontal mode, or a vertical mode;
determine that a corresponding block of a second component of the video data is intra-predicted using the same mode as the block of the first component according to a direct mode to form a predicted block for the second component;
boundary filter the predicted block in response to the determinations; and
encode the block of the second component using the boundary filtered predicted block.

24. The device of claim 23, wherein the one or more processors are further configured to determine that cross-component prediction is used to predict a residual for the corresponding block of the second component based on a residual for the block of the first component, wherein the one or more processors are configured to boundary filter the predicted block in response to the determinations that the block of the first component is intra-predicted using one of the DC mode, the horizontal mode, or the vertical mode, the corresponding block of the second component is intra-predicted using the same mode as the block of the first component according to the direct mode, and cross-component prediction is used to predict the residual for the corresponding block of the second component based on the residual for the block of the first component.

25. The device of claim 23, wherein the one or more processors are configured to boundary filter at least one of a first row or a first column of the predicted block.

26. The device of claim 23, wherein the first component comprises a luma component, and the second component comprises a chroma component.

27. The device of claim 23, wherein the first component comprises one of a green component, a red component, or a blue component, and the second component comprises another of the green component, the red component, or the blue component.

28. The device of claim 23, wherein the one or more processors are further configured to encode a syntax element, wherein the syntax element indicates whether the predicted block is boundary filtered in response to the determinations.

29. The device of claim 23, wherein the device comprises one of:
a microprocessor;
an integrated circuit (IC); or
a wireless communication device comprising the one or more processors.

30. The device of claim 23, further comprising a camera configured to capture the video data.
